(19) United States
(12) Patent Application Publication
(10) Pub. No.: US 2020/0340456 A1
(43) Pub. Date: Oct. 29, 2020

(54) REVERSE HORSE CART

(71) Applicant: Smith Mark, Tilbury (CA)

(72) Inventor: Smith Mark, Tilbury (CA)

(21) Appl. No.: 16/856,113

(22) Filed: Apr. 23, 2020

Related U.S. Application Data
(60) Provisional application No. 62/837,233, filed on Apr. 23, 2019.

(51) Int. Cl. F03G 5/04; A01K 15/02

(52) U.S. Cl. CPC F03G 5/04; B62C 1/04; A01K 15/027

(57) ABSTRACT

A reverse horse cart having a treadmill allowing an animal to walk thereon to generate power to run a vehicle. A horse is used as a source of power for a vehicle wherein the horse (or other animal) also rides on the vehicle. To collect energy from the horse in an efficient and ethical matter, the horse will walk on a treadmill causing the belt to rotate a shaft that connects to a flywheel which is communication with a generator. The generator then connects to a tray of capacitors to store the energy. After the energy is stored, the capacitors send the energy to electrical regulators, which pass the electricity to four motors that control each wheel. The motion of the wheels is controlled by a motion logic controller.

### CROSS REFERENCE TO RELATED APPLICATIONS

This application claims priority and benefit to U.S. provisional application Ser. No. 62/837,233 filed on Apr. 23, 2019.

### TECHNICAL FIELD

The present specification generally relates to horse carts, more specifically, the present specification related to a vehicle having a treadmill wherein the vehicle is powered by a horse or other animal.

### BACKGROUND

Traditional horse carts and carriages (or other horse-drawn vehicles) have been used for thousands of years for transportation purposes. Traditional horse carts include at least one horse pulling a cart (which is typically wheeled, but may include ski or sled means). In other terms, a horse-drawn vehicle is a mechanized piece of equipment pulled by one horse or by a team of horses. These vehicles typically had two or four wheels and were used to carry passengers and/or a load. Traditional horse-drawn vehicles pose several disadvantages to both humans and safety/well-being issues to the horse. These disadvantages include other vehicles on the road, animal heat-exhaustion, power inefficiencies . . . etc.

Accordingly, a need exists for alternative horse powered vehicle overcoming the aforementioned disadvantages.

### SUMMARY

In one embodiment, a horse is used as a source of power for a vehicle wherein the horse (or other animal) also rides on the vehicle. To collect energy from the horse in an efficient and ethical matter, the horse will walk on a treadmill causing the belt to rotate a shaft that connects to a flywheel which is communication with a generator. The generator then connects to a tray of capacitors to store the energy. After the energy is stored, the capacitors send the energy to electrical regulators, which pass the electricity to four motors that control each wheel. The motion of the wheels is controlled by a motion logic controller. In the present embodiment, the vehicle has space for at least two people to sit in the front, while the horse walks comfortably in the back of the vehicle.

An animal powered vehicle having a vehicle body having a platform, a treadmill connected to the platform, the treadmill having a treadmill belt allowing an animal to walk thereon, the treadmill connected to a treadmill gear, the treadmill gear in communication with a generator, the generator providing power to the vehicle to move the vehicle wherein the vehicle configured to transport at least one animal and at least one human wherein the animal rides entirely on the vehicle. In some embodiments, a flywheel is connected to the treadmill gear, the flywheel attached to the generator to collect power for storage while the treadmill belt stops moving. In other embodiments, the platform includes a stowable ramp allowing an animal to walk onto the treadmill. In some embodiments, a capacitor is used to store energy generated by the treadmill. In some embodiments, the treadmill includes a plurality of rollers positioned under the belt and a harness is provided to secure the animal to the treadmill.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a perspective view of a reverse horse cart according to one or more embodiments shown and described herein;

FIG. 2 depicts a perspective view of a treadmill of the reverse horse cart according to one or more embodiments shown and described herein;

FIG. 3 depicts a side view of a treadmill of the reverse horse cart according to one or more embodiments shown and described herein;

FIG. 4 depicts a side view of a generator connected to a treadmill of the reverse horse cart according to one or more embodiments shown and described herein;

FIG. 5 depicts an exemplary model of a tray of capacitors which is connected to the generator reverse horse cart according to one or more embodiments shown and described herein;

FIG. 6 depicts the energy generation system of the reverse horse cart according to one or more embodiments shown and described herein;

FIG. 7 depicts a perspective view of the food and water trough of the reverse horse cart according to one or more embodiments shown and described herein;

FIG. 8 depicts a perspective view of the waste collection bin of the reverse horse cart according to one or more embodiments shown and described herein;

FIG. 9 depicts a perspective view of a horse seat belt or restraining harness of the reverse horse cart according to one or more embodiments shown and described herein;

FIG. 10 depicts a perspective view of the ramp and ramp storage of the reverse horse cart according to one or more embodiments shown and described herein; and

FIG. 11 depicts a perspective view of an encouragement bar of the reverse horse cart according to one or more embodiments shown and described herein.

### DETAILED DESCRIPTION

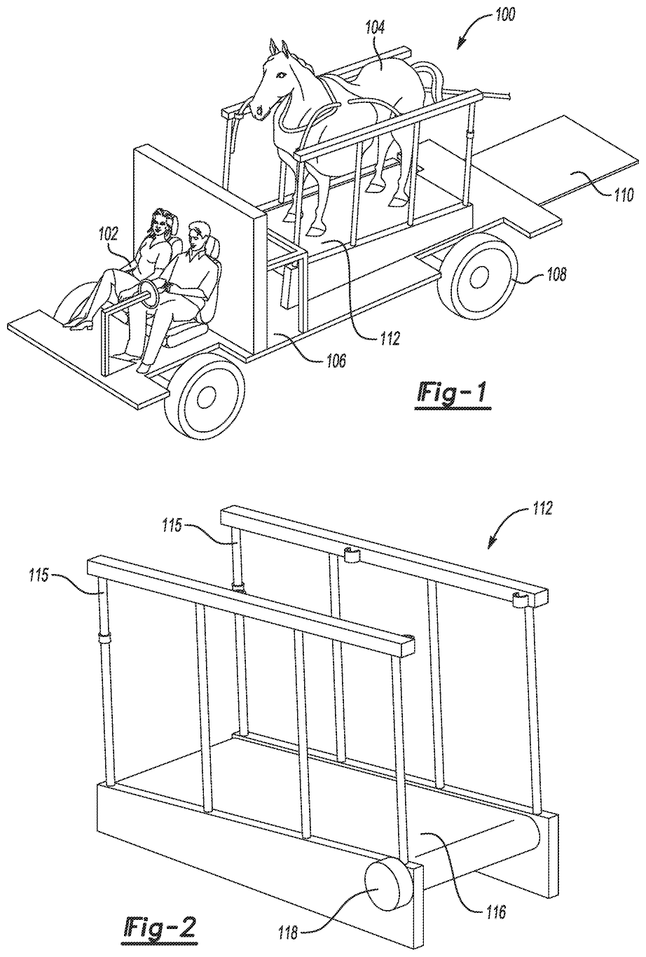

FIG. 1 generally illustrates a reverse horse cart of the present specification. To collect energy from the horse in an efficient and ethical matter, the horse will walk on a treadmill causing the belt to rotate a shaft that connects to a flywheel which is communication with a generator. The generator then connects to a tray of capacitors to store the energy. After the energy is stored, the capacitors send the energy to electrical regulators, which pass the electricity to four motors that control each wheel. The motion of the wheels is controlled by a motion logic controller. In the present embodiment, the vehicle has space for at least two people to sit in the front, while the horse walks comfortably in the back of the vehicle.

Referring now to FIG. 1, a reverse horse cart 100 is configured to carry passengers 102 and configured to be powered by a horse, or other animal, 104. The cart 100 includes a main frame 106 supported by a plurality of wheels 108. In the present embodiment, the main frame 106 is a standard type vehicle frame or platform configured to hold a plurality of passengers. The cart further includes a showable ramp 110 and a treadmill 112 configured to allow the horse to walk thereon.

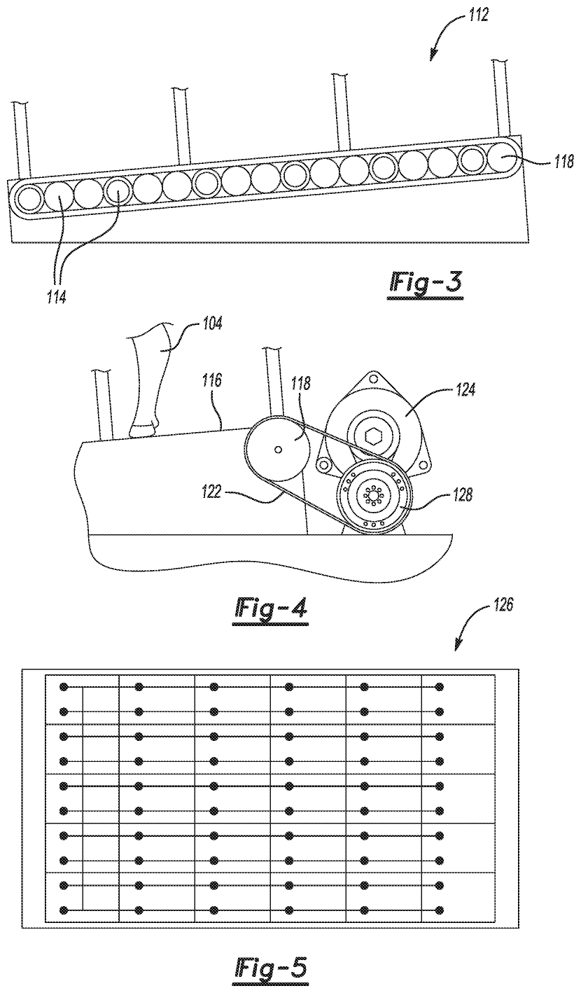

FIGS. 2 and 3 depict the treadmill 112 of the reverse horse cart according to one or more embodiments shown and described herein. The treadmill includes a belt 116 having sufficient strength, traction and resilience to allow a horse to walk thereon. The heart of the present apparatus and system in the treadmill 112. The treadmill 112 includes a plurality of rollers 114 to prevent bowing of the belt as well as providing additional support for the hose 104 to walk on. In the present embodiment, the treadmill 112 is on a 5° incline. In this embodiment, the treadmill 112 includes two Plexiglas walls 115 that keep the horse 104 corralled on the treadmill 112. A generator (discussed in the following) connect to the large wheel 118 protruding from the side of the treadmill 112 through an additional belt.

FIGS. 4 and 5 depict the generator 124 and capacitors 126 connected to the treadmill 112 of the reverse horse cart 100 according to one or more embodiments shown and described herein. The large wheel 118 of the treadmill 112 connects to a flywheel 128 by means of a belt 122. The flywheel 128 attaches to the generator 124 to collect the power for storage in the capacitors 126. The purpose of the flywheel 128 is to keep generating energy while the horse 104 rests. In this embodiment, the capacitor tray includes space for 30 capacitors 126. Each of the capacitors will be linked in parallel to store the electricity generated by the horse.

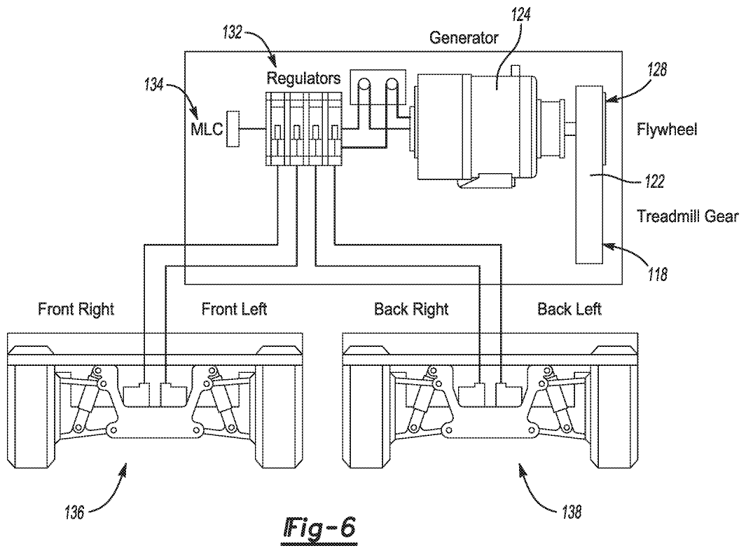

FIG. 6 depicts the energy generation system of the reverse horse cart 100 according to one or more embodiments shown and described herein. This system generally includes the generator 124, the flywheel 128, the large wheel 118 of the treadmill 112 and the belt 122 connecting the large wheel 118 to the flywheel 128. The regulators 132 and MLC 134 control power to the drive systems 136, 138.

FIG. 7 depicts a food and water trough 140 of the reverse horse cart according to one or more embodiments shown and described herein. To keep the horse 104 energized and comfortable, a food and water trough 140 is stationed in front of the treadmill 112.

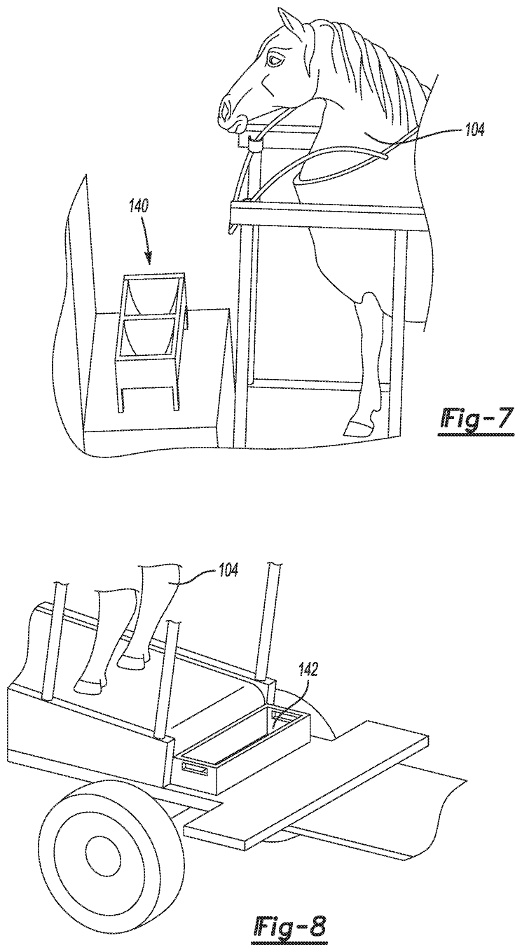

FIG. 8 depicts a waste collection bin 142 of the reverse horse cart 100 according to one or more embodiments shown and described herein. To collect the horse's 104 waste, a collection bin 142 is placed at the back of the treadmill 112.

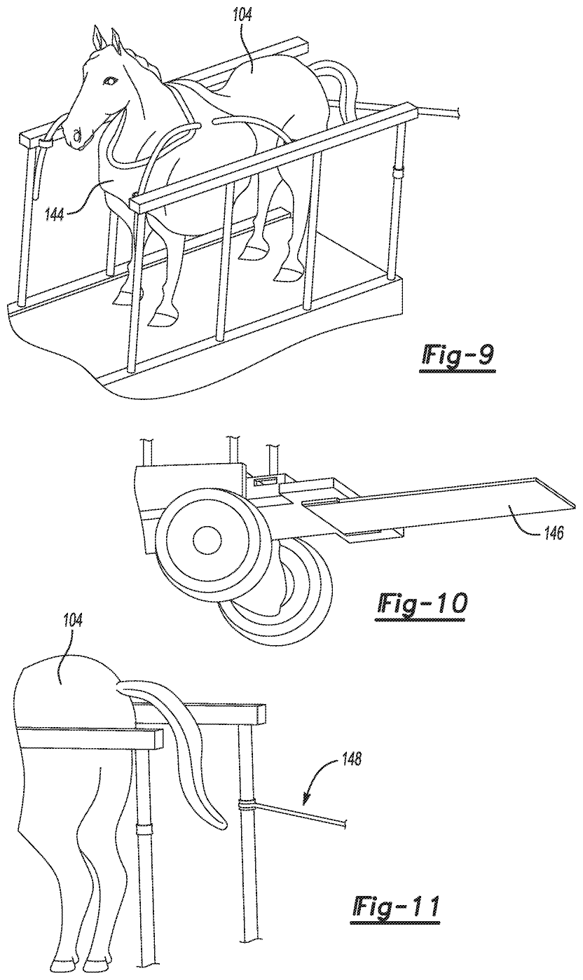

FIG. 9 depicts a horse seat belt or restraining harness 144 of the reverse horse cart 100 according to one or more embodiments shown and described herein. To keep the horse 104 from falling off of the treadmill when the vehicle is moving, the harness will hold the horse in place for safety reasons.

FIG. 10 depicts a ramp 146 and ramp storage of the reverse horse cart 100 according to one or more embodiments shown and described herein. To load the horse 104 into the vehicle, a ramp 146 will be stored beneath the chassis.

FIG. 11 depicts an encouragement bar 148 of the reverse horse cart 100 according to one or more embodiments shown and described herein. The encouragement bar 148 is to ensure that the horse moves forward. The encouragement may be slightly electrified or may provide vibratory feedback to the horse 104.

A barrier wall and passenger seating area is provided included in the reverse horse cart according to one or more embodiments shown and described herein. To prevent the horse 104 from reaching the passengers 102, the barrier wall will separate the horse 104 from the passengers 102.

The figures depict various view of the cart 100 according to one or more embodiments shown and described herein. The figures depict various views of the entire cart 100. As with prior embodiments, the cart is configured to carry passengers 102 and configured to be powered by a horse, or other animal, 104. The cart 100 includes a main frame 106 supported by a plurality of wheels 108. In the present embodiment, the main frame 106 is a standard type vehicle frame or platform configured to hold a plurality of passengers. The cart further includes a showable ramp 110 and a treadmill 112 configured to allow the horse to walk thereon.

In this embodiment, as with the prior embodiments, the treadmill 112 of the reverse horse cart according to one or more embodiments shown and described herein. The treadmill includes a belt 116 having sufficient strength, traction and resilience to allow a horse to walk thereon. The heart of the present apparatus and system in the treadmill 112. The treadmill 112 includes a plurality of rollers 114 to prevent bowing of the belt as well as providing additional support for the hose 104 to walk on. In the present embodiment, the treadmill 112 is on a 5° incline. In this embodiment, the treadmill 112 includes two Plexiglas wall 115 that keep the horse 104 corralled on the treadmill 112. A generator connect to the large wheel 118 protruding from the side of the treadmill 112 through an additional belt.

An exemplary model of the generator 124 of the reverse horse cart according to one or more embodiments shown and described herein. Similarly, the capacitors 126 are depicted. The generator 124 and capacitors 126 connected to the treadmill 112 of the reverse horse cart 100 according to one or more embodiments shown and described herein. The large wheel 118 of the treadmill 112 connects to a flywheel 128 by means of a belt 122. The flywheel 128 attaches to the generator 124 to collect the power for storage in the capacitors 126. The purpose of the flywheel 128 is to keep generating energy while the horse 104 rests. In this embodiment, the capacitor tray includes space for 30 capacitors 126. Each of the capacitors will be linked in parallel to store the electricity generated by the horse.

It is noted that the terms “substantially” and “about” may be utilized herein to represent the inherent degree of uncertainty that may be attributed to any quantitative comparison, value, measurement, or other representation.

These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter.

Moreover, although various aspects of the claimed subject matter have been described herein, such aspects need not be utilized in combination.

It is therefore intended that the appended claims cover all such changes and modifications that are within the scope of the claimed subject matter.

1. An animal powered vehicle comprising:
a vehicle body having a platform, a treadmill connected to the platform, the treadmill having a treadmill belt allowing an animal to walk thereon, the treadmill connected to a treadmill gear, the treadmill gear in communication with a generator; and
the generator providing power to the vehicle to move the vehicle;
wherein the vehicle is configured to transport at least one animal and at least one human wherein the animal rides entirely on the vehicle while also powering the vehicle.

2. The animal powered vehicle of claim 1 wherein a flywheel is connected to the treadmill gear, the flywheel attached to the generator to collect power for storage while the treadmill belt stops moving.

3. The animal powered vehicle of claim 1 wherein the platform includes a stowable ramp allowing an animal to walk onto the treadmill.

4. The animal powered vehicle of claim 1 wherein a capacitor is used to store energy generated by the treadmill.

5. The animal powered vehicle of claim 1 wherein the treadmill includes a plurality of rollers positioned under the belt.

6. The animal powered vehicle of claim 1 wherein a harness is provided to secure the animal to the treadmill.
